(19) United States
(12) Patent Application Publication
(10) Pub. No.: US 2024/0384128 A1
(43) Pub. Date: Nov. 21, 2024

(54) LOW VOLATILE ORGANIC CONTENT WATER REDUCIBLE FLUID RESISTANT COATING

(71) Applicant: PRC-Desoto International, Inc., Sylmar, CA (US)

(72) Inventors: Mariette Hickman, Burbank, CA (US); Guangliang Tang, Stevenson Ranch, CA (US)

(73) Assignee: PRC-Desoto International, Inc., Sylmar, CA (US)

(21) Appl. No.: 18/692,043

(22) PCT Filed: Sep. 8, 2022
(86) PCT No.: PCT/US2022/076097

§ 371 Date: Mar. 14, 2024

Related U.S. Application Data
(60) Provisional application No. 63/261,302, filed on Sep. 17, 2021.

(51) Int. Cl. C09D 163/00; C09D 5/02; C09D 7/20; C09D 175/04

(52) U.S. Cl. CPC C09D 163/00; C09D 5/021; C09D 7/20; C09D 175/04

(57) ABSTRACT

Water reducible coatings having a low volatile organic content and that are resistant to aerospace solvents are disclosed. The coatings include an epoxy resin component and an amine component. The epoxy resin component comprises a difunctional polyepoxy resin, a multifunctional aliphatic polyepoxy resin, and a polyacetoacetate resin. The amine component comprises a polyepoxy-polyamine adduct and a methylene bridged poly(cyclohexyl-aromatic) amine.

### FIELD

The present disclosure relates to water reducible coatings having a low volatile organic content and that are resistant to aerospace solvents are disclosed. The coatings include an epoxy resin component and an amine component. The epoxy resin component comprises a difunctional polyepoxy resin, a multifunctional aliphatic polyepoxy resin, and a polyacetoacetate resin. The amine component comprises a polyepoxy-polyamine adduct and a methylene bridged poly(cyclohexyl-aromatic) amine.

### BACKGROUND

To meet aerospace coating requirements, it is desirable that an aerospace coating have a low volatile organic content, a long pot life, a fast-curing time, exhibit resistance to various solvents including phosphate ester-based hydraulic fluids, and exhibit adhesion to a substrate and a topcoat during a wide range of use conditions.

### SUMMARY

According to the present invention, coating compositions comprise a polyepoxide-polyamine adduct; an aromatic/cycloaliphatic polyamine; a difunctional polyepoxide; an aliphatic multifunctional polyepoxide; and a polyacetoacetate.

According to the present invention, multi-component coating systems comprise a polyamine component, wherein the polyamine component comprises: a polyepoxy-polyamine adduct; and an aromatic/cycloaliphatic polyamine; and a polyepoxide component, wherein the polyepoxide component comprises: a difunctional polyepoxide; an aliphatic multi-functional polyepoxide; and a polyacetoacetate.

### DETAILED DESCRIPTION

For purposes of the following detailed description, it is to be understood that embodiments provided by the present disclosure may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

When reference is made to a chemical group defined, for example, by a number of carbon atoms, the chemical group is intended to include all sub-ranges of carbon atoms as well as a specific number of carbon atoms. For example, a C₂₋₁₀ alkanediyl includes a C₂₋₄ alkanediyl, C₅₋₇ alkanediyl, and other sub-ranges, a C₂ alkanediyl, a C₆ alkanediyl, and alkanediyls having other specific number(s) of carbon atoms from 2 to 10.

A coating composition refers to a curable composition used to prepare a coating. Coating components such as a polyamine component and a polyepoxide component can be combined and mixed to provide a curable coating composition. After being applied to a substrate, the reactants of the applied coating composition react to first provide a partially cured coating and then fully react to provide a cured coating.

Drying time of a coating composition is determined according to ASTM D5895.

Jet Reference Fluid JRF Type I, as employed for determination of fuel resistance, has the following composition: toluene: 28%±1% by volume; cyclohexane (technical): 34%±1% by volume; isooctane: 38%±1% by volume; and tertiary dibutyl disulfide: 1%±0.005% by volume (see AMS 2629, issued Jul. 1, 1989, § 3.1.1 etc., available from SAE (Society of Automotive Engineers)).

“Number average molecular weight” refers to the total weight of a material divided by the number of molecules in the material and can be determined using gel permeation chromatography.

The particle size is determined by dynamic light scattering using a Malvern Autosizer Lo-C.

Pot life is determined by measuring the viscosity according to ASTM D1200. Pot life is the duration from the time when a coating composition is first prepared by combining the polyepoxide component, the polyamine component, and optional solvent until the time when the viscosity of the coating composition can no longer be applied using the intended application method. For example, a sprayable coating composition can have a viscosity, for example, from 20 to 70 seconds at 25° C. as determined according to ASTM D1200 with Ford Cup Number 4.

The solids content is determined according to ISO 3251.

Solvent refers to water and/or organic solvent.

Specific gravity is determined according to ISO 787-11.

Skydrol® is a fire-resistant hydraulic fluid based on phosphate ester chemistry. Skydrol® fluids including Skydrol® 500B-4, Skydrol® LD-4, Skydrol® 5, and Skydrol® PE-5 are commercially available from Eastman Chemical Company. Skydrol® LD-4 contains 55 wt % to 65 wt % tributyl phosphate, 20 wt % to 40 wt % of butyl diphenyl phosphate, dibutyl phenyl phosphate and tributyl phosphate, less than 10 wt % 2-ethylhexyl 7-oxabicyclo[4.1.0]heptane-3-carboxylate, and 1 wt % butylated hydroxytoluene, where wt % is based on the total weight of the hydraulic fluid.

The viscosity of viscous resins and compositions is determined using a Brookfield LVT viscometer with No. 3 spindle and 60 revolutions per minute (RPM) at 20° C.

The viscosity of Newtonian or near-Newtonian compositions such as sprayable coating compositions provided by the present disclosure is determined according to ASTM D1200, Standard Test Method for Viscosity by Ford Viscosity Cup.

“Volatile organic content” (VOC) refers to is defined in 40 Code of Federal Regulations Part 15.100(s) as any compound of carbon, excluding carbon monoxide, carbon dioxide, carbonic acid, metallic carbides or carbonates, and ammonium carbonate, which participates in atmospheric photochemical reactions. Volatile organic content (VOC) is determined according to ASTM D2369.

Reference is now made to certain compounds, compositions, and methods of the present invention. The disclosed compounds, compositions, and methods are not intended to be limiting of the claims. To the contrary, the claims are intended to cover all alternatives, modifications, and equivalents.

A coating composition provided by the present disclosure can comprise a polyepoxy-polyamide adduct; an aromatic/cycloaliphatic polyamine; a difunctional polyepoxide; an aliphatic multifunctional polyepoxide; and a polyacetoacetate.

A coating composition provided by the present disclosure can comprise solids and solvent. Solvent can be added to the solids content to adjust the coating composition to have a viscosity suitable for an intended method of application such as spray coating. For example, a sprayable coating composition refers to a coating composition that can be applied by spraying a sprayable coating composition can have a viscosity, for example, from 20 Pa·sec to 40 Pa·sec at 25° C. as determined according to ASTM D1200 with a Ford Cup Number 4.

A coating composition provided by the present disclosure can comprise a polyepoxy-polyamine adduct, or a combination of polyepoxy-polyamine adducts.

A polyepoxy-polyamine adduct can be derived from the reaction of polyamines with compounds containing a glycidyl ether group. A polyepoxy-polyamine adduct can be prepared by reacting a polyamine with a polyepoxide such as a monoepoxide, a diepoxide, a polyepoxide, or a combination of any of the foregoing.

Suitable polyepoxy-polyamine adducts and methods of preparing polyepoxy-polyamine adducts are disclosed, for example, in U.S. Pat. No. 4,352,898.

Examples of suitable poly amine-monoepoxide adducts can be based on monofunctional aliphatic glycidyl ethers, styrene oxide, pentachlorophenyl glycidyl ether, reaction products of epichlorohydrin and bisphenol A containing phenolic hydroxyls and less than one epoxy group per molecule, and epoxidized olefins from unsaturated fatty acid glycerides with less than one epoxy group per molecule.

Examples of suitable polyamine-diepoxide adducts can be based on the diglycidyl ether of bisphenol A (DGEBA), the diglycidyl ether of 4,4′-isopropylidenedicylohexanol, diglycidyl ether of hydantoin, diepoxides obtained by epoxidation of aliphatic and/or cyclo-aliphatic polyolefins, and diglycidyl ethers of polyoxyalkylene glycol.

Examples of suitable polyepoxy-polyamine adducts are commercially available under the tradenames Epotuf® from Reichold and Versamid® from Huntsman.

A polyepoxy-polyamine adduct can have an amine equivalent weight, for example, from 0.1 g/eq to 0.3 g/eq, from 0.12 g/eq to 0.28 g/eq, from 0.14 g/eq to 0.26 g/eq, or from 0.16 g/eq to 0.22 g/eq, such as about 0.18 g/eq. A polyepoxy-polyamine adduct can have an amine equivalent weight, for example, greater than 0.1 g/eq, greater than 0.14 g/eq, greater than 0.20 g/eq, greater than 0.24 g/eq, greater than 0.28 g/eq. A polyepoxy-polyamine adduct can have an amine equivalent weight, for example, less than 0.30 g/eq, less than 0.26 g/eq, less than 0.22 g/eq. less than 0.18 g/eq, or less than 0.14 g/eq.

A polyepoxy-polyamine adduct can have a hydrogen equivalent weight, for example, from 0.1 g/eq to 0.3 g/eq, from 0.12 g/eq to 0.28 g/eq, fmm 0.14 g/eq, to 0.26 g/eq, or from 0.16 g/eq to 0.24 g/eq. such as about 21 g/eq. A polyepoxy-polyamine adduct can have a hydrogen equivalent weight, for example, greater than 0.10 g/eq, greater than 0.14 g/eq, greater than 0.18 g/eq, greater than 0.22 g/eq, or greater than 0.26 g/eq. A polyepoxy-polyamine adduct can have a hydrogen equivalent weight, for example, less than 0.30 g/eq, less than 0.26 g/eq, less than 0.22 g/eq, less than 0.18 g/eq, or less than 0.14 g/eq.

A polyepoxy-polyamine adduct can have an amine value of less than about 400. At amine values higher than about 400, a coating composition comprising the polyepoxy-polyamine adduct can have too short a pot life and the coating films formed may not be flexible. A polyepoxy-polyamine adduct can have an amine value from 150 to 300. “Amine value” refers to the milligrams of KOH which are equivalent to 1 gram of the polyepoxy-polyamine adduct.

A coating composition provided by the present disclosure can comprise, for example, from 10 wt % to 40% of a polyepoxy-polyamine adduct, from 15 wt % to 35 wt %, or from 20 wt % to 30 wt % of a polyepoxide-polyamine adduct, where wt % is based on the total solids weight of the coating composition.

A coating composition provided by the present disclosure can comprise, for example, greater than 10 wt %, greater than 20 wt %, or greater than 30 wt %, of a polyepoxide-polyamine adduct, where wt % is based on the total solids weight of the coating composition.

A coating composition provided by the present disclosure can comprise, for example, less than 40 wt %, less than 30 wt %, or less than 20 wt %, of a polyepoxide-polyamine adduct, where wt % is based on the total solids weight of the coating composition.

A coating composition provided by the present disclosure can comprise an aromatic/cycloaliphatic polyamine or a combination of aromatic/cycloaliphatic polyamines.

An aromatic/cycloaliphatic polyamine can comprise aromatic groups and cycloaliphatic groups in the polyamine backbone with amines bonded to the aromatic and cycloaliphatic groups.

An aromatic/cycloaliphatic polyamine can comprise a methylene-bridged poly(cyclohexyl-aromatic) amine (MPCA). MPCA can comprise a mixture of methylene bridged poly(cyclohexyl-aromatic)amines) obtained by the hydrogenation of crude methylenedianiline and partial distillation with the main component being a hydrogenated formaldehyde polymer with benzenamine (CAS No. 135108-88-2).

Examples of MPCAs are disclosed, for example, in U.S. Pat. Nos. 5,280,091 and 6,952,964.

An MPCA for use in a coating composition provided by the present disclosure can have, for example, from 0.001 amine equivalents to 0.010 amine equivalents, such as from 0.003 amine equivalents to 0.007 amine equivalents. An MPCA can have, for example, greater than 0.001 amine equivalents, greater than 0.003, greater than 0.006, or greater than 0.009 amine equivalents. An MPCA can have, for example, less than 0.010 amine equivalents, less than 0.007, or less than 0.004 amine equivalents.

An MPCA can have an amine hydrogen equivalent weight, for example, from 50 g/eq to 150 g/eq, from 70 g/eq to 130 g/eq, or from 90 g/eq to 120 g/eq. An MPCA can have an amine hydrogen equivalent weight, for example, greater than 50 g/eq, greater than 75 g/eq, greater than 100 g/eq, or greater than 125 g/eq. An MPCA can have an amine hydrogen equivalent weight, for example, less than 150 g/eq, less than 125 g/eq, less than 100 g/eq, less than 75 g/eq, or less than 50 g/eq. The amine hydrogen equivalent weight is calculated based on the amine value as determined according to ASTM D2896.

Examples of suitable aromatic/cycloaliphatic polyamines include, for example, Ancamine® 2280, Ancamine® 2608, Ancamine® 2692, Ancamine® 2486, Ancamine® 2386, Ancamine® 2168, and combinations of any of the foregoing. Ancamine® products are available from Evonik Industries.

An aromatic/cycloaliphatic polyamine can be selected, for example, from Anacamine® 2280, Anacamine® 2264, and combinations thereof.

A coating composition provided by the present disclosure can comprise, for example, from 0.1 wt % to 3 wt % of an aromatic/cycloaliphatic polyamine, from 0.1 wt % to 2.5 wt %, from 0.1 wt % to 2.0 wt %, from 0.1 wt % to 1.0 wt %, or from 0.1 wt % to 0.5 wt % of an aromatic/cycloaliphatic polyamine, where wt % is based on the total solids weight of the coating composition.

A coating composition provided by the present disclosure can comprise, for example, greater than 0.1 wt %, greater than 0.2 wt %. greater than 0.5 wt %, greater than 1.0 wt %, or greater than 2.0 wt % of an aromatic/cycloaliphatic polyamine, where wt % is based on the total solids weight of the coating composition.

A coating composition provided by the present disclosure can comprise, for example, less than 3.0 wt %, less than 2.0 wt %, less than 1.0 wt %, or less than 0.5 wt % of an aromatic/cycloaliphatic polyamine, where wt % is based on the total solids weight of the coating composition.

A coating composition provided by the present disclosure can comprise a difunctional polyepoxide or a combination of difunctional polyepoxides.

A difunctional polyepoxide can comprise a difunctional bisphenol A polyepoxide, a difunctional bisphenol F polyepoxide, a difunctional novolac polyepoxide, or a combination of any of the foregoing.

A difunctional polyepoxide can have an epoxy equivalent weight, for example, from 150 g/eq to 250 g/eq such as from 175 g/eq to 225 g/eq, where the epoxy equivalent weight is determined according to ASTM D1652. A difunctional polyepoxide can have an epoxy equivalent weight, for example, greater than 150 g/eq, greater than 175 g/eq, greater than 200 g/eq, or greater than 225 g/eq. A difunctional polyepoxide can have an epoxy equivalent weight, for example, less than 250 g/eq, less than 225 g/eq, less than 200 g/eq, or less than 175 g/eq.

A difunctional polyepoxide can have, for example, from 0.05 epoxy equivalents to 0.20 epoxy equivalents, such as from 0.08 epoxy equivalents to 0.16 epoxy equivalents or from 0.1 to 0.14 epoxy equivalents.

Examples of suitable diepoxides include diglycidyl ether, 1,4-butanediol diglycidyl ether, neopentyl glycol diglycidyl ether, 1,3-butanediol diglycidyl ether, Neopentyl glycol diglycidyl ether, dipropylene glycol diglycidyl ether, 1,6-hexanediol diglycidyl ether, ethylene glycol diglycidyl ether, diethylene glycol diglycidyl ether, glycerol 1,3-diglycidyl ether, etoglucid, 1,5-hexadiene diepoxide, diepoxy propyl ether, 1,5-hexadiene diepoxide, 1,2:9,10-diepoxydecane, 1,2:8,9-diepoxynonane, and 1,2:6,7-diepoxyheptane; aromatic diepoxides such as resorcinol diglycidyl ether, bisphenol A diglycidyl ether, bisphenol F diglycidyl ether, bis[4-(glycidyloxy)phenyl]methane, 1,4-bis(glycidyloxy)benzene, tetramethylbiphenyl diglycidyl ether, and 4,4-diglycidyloxybiphenyl; and cyclic diepoxides such as 1,4-cyclohexanedimethanol diglycidyl ether, hydrogenated bisphenol A diglycidyl ether, and 1,4-bis(glycidyloxy)cyclohexane.

Examples of suitable difunctional polyepoxides include bisphenol A diglycidyl ether, bisphenol E diglycidyl ether (bis(4-glycidyloxyphenyl)methane), bisphenol F diglycidyl ether (2,2′-[1,1-ethanediylbis(4,1-phenylene oxymethylene)]dioxirane.

A coating composition provided by the present disclosure can comprise, for example, from 10 wt % to 40 wt % of a difunctional polyepoxide, from 15 wt % to 35 wt %, or from 20 wt % to 30 wt % of a difunctional polyepoxide, where wt % is based on the total solids weight of the coating composition.

A coating composition provided by the present disclosure can comprise, for example, greater than 10 wt % of a difunctional polyepoxide, greater than 20 wt %, or greater than 30 wt % of a difunctional polyepoxide, where wt % is based on the total solids weight of the coating composition.

A coating composition provided by the present disclosure can comprise, for example, less than 40 wt % of a difunctional polyepoxide, less than 30 wt %, or less than 20 wt % of a difunctional polyepoxide, where wt % is based on the total solids weight of the coating composition.

A coating composition provided by the present disclosure can comprise an aliphatic multifunctional polyepoxide or a combination of aliphatic multifunctional polyepoxides.

An aliphatic multifunctional polyepoxide can improve the solvent resistance and reduce the VOC of a coating composition.

An aliphatic multifunctional polyepoxide can act as a reactive diluent and can reduce the viscosity of a coating composition.

An aliphatic multifunctional polyepoxide can have an average epoxy functionality, for example, from 3 to 6, such as 3, 4, 5, or 6.

An aliphatic multifunctional polyepoxide can have an epoxy equivalent weight, for example, from 80 g/eq to 200 g/eq, from 80 g/eq to 180 g/eq, from 100 g/eq to 160 g/eq, or from 120 g/eq to 140 g/eq. An aliphatic multifunctional polyepoxide can have an epoxy equivalent weight, for example, greater than 80 g/eq, greater than 100 g/eq, greater than 120 g/eq, greater than 140 g/eq, or greater than 160 g/eq. An aliphatic multifunctional polyepoxide can have an epoxy equivalent weight, for example, less than 200 g/eq, less than 180 g/eq, less than 160 g/eq, less than 140 g/eq, less than 120 g/eq, or less than 100 g/eq.

An aliphatic multifunctional polyepoxide can have, for example, from 0.005 epoxy equivalents to 0.020 epoxy equivalents, such as from 0.007 epoxy equivalents to 0.018 epoxy equivalents.

Examples of suitable aliphatic multifunctional polyepoxide reactive diluents includes 1,4-dihydroxybutane diglycidyl ether, cyclohexanedimethanol diglycidyl ether, neopentyl glycol diglycidyl ether, dihydroxyhexane diglycidyl ether and/or propylene glycol diglycidyl ether, glycerin triglycidyl ether, pentaerythritol tetraglycidyl ether, trimethylolpropane triglycidyl ether, and combinations of any of the foregoing.

Examples of suitable aliphatic multifunctional polyepoxides include Aradalite® DY-T or Aradilite® DY-S available from Huntsman Advanced Materials.

Other examples of suitable aliphatic multifunctional polyepoxides include Erisys® GE-30, Erisys® GE-31, Erisys® GE-40, Erisys® GE-50, Erisys® GE-61, available from Huntsman.

A coating composition provided by the present disclosure can comprise, for example, from 0.5 wt % to 5.0 wt % of an aliphatic multifunctional polyepoxide, from 1.0 wt % to 4.0 wt %, or from 2.0 wt % to 3.0 wt % of an aliphatic multifunctional polyepoxide, where wt % is based on the total solids weight of the coating composition.

A coating composition provided by the present disclosure can comprise, for example, greater than 0.5 wt %, greater than 1 wt %, greater than 2 wt %, greater than 3 wt %, or greater than 4 wt % of an aliphatic multifunctional polyepoxide, where wt % is based on the total solids weight of the coating composition.

A coating composition provided by the present disclosure can comprise, for example, less than 5 wt %, less than 4 wt %, less than 3 wt %, less than 2 wt %, or less than 1 wt % of an aliphatic multifunctional polyepoxide, where wt % is based on the total solids weight of the coating composition.

A coating composition provided by the present disclosure can comprise a polyacetoacetate resin or a combination of polyacetoacetate resins.

A polyacetoacetate resin can comprise two or more reactive acetoacetate groups.

A polyacetoacetate resin can serve as a reactive diluent and can improve intercoat adhesion and solvent resistance.

Polyacetoacetate resins are highly reactive, low viscous functional resin modifiers. Polyacetoacetate resins can undergo a variety of (crosslinking) reactions.

Polyacetoacetates are acetoacetate-functional compounds having at least two acetoacetate groups and are described, for example in U.S. Pat. Nos. 3,668,183, 5,021,537. Polyacetoacetates can comprise the partial or complete acetoacetylation product of a monomeric polyalcohol having at least two free hydroxyl groups or an oligonieric or polymeric condensation derivative of such polyalcohols.

For example, a polyacetoacetate resin can have from two to four functional groups of the formula —O—C(═O)—CH₂—C(═O)—CH₃ and a molecular weight within the range, for example, from 200 Daltons to 800 Daltons. Examples of suitable polyacetoacetates include the bisacetoacetates of dipropylene glycol, ethylene glycol and neopentyl glycol; the trisacetoacetates of trimethylolpropane, trimethylolethane, glycerol and bisttrimethylolpropane); and the tetrakis acetoacetate of pentaerythritol. Suitable polyacetoacetates include trisacetoacetates, which are non-volatile and demonstrate the ability to impart low viscosity and rapid dry times to high-solids coatings.

A polyacetoacetate resin can have an average acetoacetate functionality, for example, from 2 to 6, such as 2, 3, 4, 5, or 6.

A polyacetoacetate resin can have an acetoacetate equivalent weight, for example, from 100 g/eq to 500 g/eq, from 150 g/eq to 450 g/eq, from 200 g/eq to 400 g/eq, or from 250 g/eq to 350 g/eq. A polyacetoacetate resin can have an acetoacetate equivalent weight, for example, greater than 100 g/eq, greater than 200 g/eq, greater than 300 g/eq, or greater than 400 g/eq. A polyacetoacetate resin can have an acetoacetate equivalent weight, for example, less than 500 g/eq, less than 400 g/eq, less than 300 g/eq, or less than 200 g/eq. The acetoacetate equivalent weight can be calculated based on the molecular weight of the polyacetoacetate and the acetoacetate group.

A polyacetoacetate resin can have a viscosity, for example, from 100 cPs to 2,000 cPs at 25° C. as determined using a Brookfield viscometer.

Examples of suitable polyacetoacetate resins include K-Flex@ 7301, K-Flex® XM-B301, K-Flex® 301, which are available from King Industries.

Examples of suitable polyacetoacetate resins include Acure@ 510-440 available from Allnex.

A polyacetoacetate resin can comprise an aliphatic polyacetoacetate.

A coating composition provided by the present disclosure can comprise, for example, from 0.3 wt % to 3.0 wt % of a polyacetoacetate, from 0.5 wt % to 2.5 wt %, or from 1.0 to 2.0 wt % of a polyacetoacetate resin, where wt % is based on the total solids weight of the coating composition.

A coating composition provided by the present disclosure can comprise, for example, greater than 0.3 wt % of a polyacetoacetate, greater than 0.5 wt %, greater than 1 wt %, greater than 1.5 wt %, greater than 2.0 wt %, or greater than 2.5 wt % of a polyacetoacetate, where wt % is based on the total solids weight of the coating composition.

A coating composition provided by the present disclosure can comprise, for example, less than 3 wt %, less than 2.5 wt %, less than 2.0 wt %, less than 1.5 wt %, or less than 1.0 wt % of a polyacetoacetate, where wt % is based on the total solids weight of the coating composition.

A coating composition provided by the present disclosure can comprise, for example, from 10 wt % to 40 wt % of a polyepoxide-polyamine adduct; from 0.1 wt % to 2.0 wt % an aromatic/cycloaliphatic polyamine; from 10 wt % to 40 wt % a difunctional epoxide; from 0.5 wt % to 5.0 wt % an aliphatic multifunctional polyepoxide; and from 0.3 wt % to 3.0 wt % a polyacetoacetate, where wt % is based on the total solids weight of the composition.

A coating composition provided by the present disclosure can comprise, for example, from 15 wt % to 35 wt % of a polyepoxide-polyamine adduct; from 0.2 wt % to 1.0 wt % an aromatic/cycloaliphatic polyamine; from 15 wt % to 35 wt % a difunctional epoxide; from 1.0 wt % to 4.0 wt % an aliphatic multifunctional 1 polyepoxide; and from 0.5 wt % to 2.0 wt % a polyacetoacetate, where wt % is based on the total solids weight of the composition.

A coating composition provided by the present disclosure can comprise, for example, from 20 wt % to 30 wt % of a polyepoxide-polyamine adduct; from 0.2 wt % to 0.5 wt % an aromatic/cycloaliphatic polyamine; from 20 wt % to 30 wt % a difunctional epoxide; from 1.0 wt % to 3.0 wt % an aliphatic multifunctional polyepoxide; and from 0.5 wt % to 1.5 wt % a polyacetoacetate, where wt % is based on the total solids weight of the composition.

A coating composition provided by the present disclosure can comprise an additive or combination of additives.

Examples of suitable additives include fillers, adhesion promoters, reactive diluents, plasticizers, rheology modifiers, thickeners, dispersants, leveling agents, colorants, catalysts, fire retardants, antioxidants, UV stabilizers, corrosion inhibitors, erosion inhibitors, and combinations of any of the foregoing.

A coating composition provided by the present disclosure can comprise a rheology modifier or a combination of rheology modifiers.

A coating can be included in a coating composition to adjust the viscosity of the coating composition and to facilitate application and to build a high film thickness. A rheology modifier can minimize settling of particulates in a coating composition and can minimize sagging of an applied composition.

A rheology modifier is distinguished from other reactants and additives that influence the rheological properties of a coreactive composition. For example, the molecular weight of the coreactants, the backbone chemistry of the prepolymers, the amount of filler, and/or the type of filler can influence the rheological properties of a coreactive composition.

Examples of suitable rheology modifiers include phthalates, terephathlic, isophathalic, hydrogenated terphenyls, quaterphenyls and higher or polyphenyls, phthalate esters, chlorinated paraffins, modified polyphenyl, tung oil, benzoates, dibenzoates, thermoplastic polyurethane plasticizers, phthalate esters, naphthalene sulfonate, trimellitates, adipates, sebacates, maleates, sulfonamides, organophosphates, polybutene, butyl acetate, butyl cellosolve, butyl carbitol acetate, dipentene, tributyl phosphate, hexadecanol, diallyl phthalate, sucrose acetate isobutyrate, epoxy ester of iso-octyl tallate, benzophenone, and combinations of any of the foregoing.

Examples of suitable rheology modifiers include cellulose ethers such as hydroxyethyl cellulose, alkali soluble emulsions, hydrophobically-modified alkali soluble emulsions, hydrophobically-modified ethylene oxide-based urethane, bentonite clay, smectite clay, and combinations of any of the foregoing.

A rheology modifier can comprise a polyether polyurethane thickener such as Rheolate® 288 available from Elementis.

A rheology modifier can comprise microfibrillated cellulose.

Examples of suitable microfibrillated cellulose rheology modifiers include Exilva® F 01-V, Sappi Valida® S191C, and combinations of any of the foregoing.

A coating composition provided by the present disclosure can comprise, for example, from 0.1 wt % to 4.0 wt % of a rheology modifier, from 0.5 wt % to 3.0 wt %, or from 1.0 wt % to 2.0 wt % of a rheology modifier, where wt % is based on the total solids weight of the coating composition. A coating composition provided by the present disclosure can comprise, for example, greater than 0.1 wt %, greater than 0.5 wt %, greater than 1 wt %, greater than 2 wt %, or greater than 3 wt % of a rheology modifier, where wt % is based on the total solids weight of the coating composition. A coating composition provided by the present disclosure can comprise, for example, less than 4.0 wt % of a rheology modifier, less than 3.0 wt %, less than 2.0 wt %, or less than 1.0 wt % of a rheology modifier, where wt % is based on the total solids weight of the coating composition.

A coating composition provided by the present disclosure can comprise a fire retardant or a combination of fire retardants.

A fire retardant can include an inorganic fire retardant, an organic fire retardant, or a combination thereof.

Examples of suitable inorganic fire retardants include aluminum hydroxide, magnesium hydroxide, zinc borate, antimony oxides, hydro magnesite, aluminum trihydrate (ATH), calcium phosphate, titanium oxide, zinc oxide, magnesium carbonate, barium sulfate, barium borate, kaolinite, silica, antimony oxides, and combinations of any of the foregoing.

Examples of suitable organic fire retardants include halocarbons, halogenated esters, halogenated ethers, chlorinated and/or brominated flame retardants, halogen free compounds such as organophosphorus compounds, organonitrogen compounds, and combinations of any of the foregoing.

A fire retardant can comprise, for example, aluminum trihydrate.

A coating composition provided by the present disclosure can comprise, for example, from 2 wt % to 12 wt % of a fire retardant, from 3 wt % to 11 wt %, from 4 wt % to 10 wt %, from 5 wt % to 9 wt %, or from 6 wt % to 8 wt % of a fire retardant, where wt % is based on the total solids weight of the coating composition. A coating composition provided by the present disclosure can comprise, for example, greater than 2 wt %, greater than 4 wt %, greater than 6 wt %, greater than 8 wt %, or greater than 10 wt % of a fire retardant, where wt % is based on the total solids weight of the coating composition. A coating composition provided by the present disclosure can comprise, for example, less than 12 wt %, less than 10 wt %, less than 8 wt %, less than 6 wt %, or less than 4 wt % of a fire retardant, where wt % is based on the total solids weight of the coating composition.

A coating composition provided by the present disclosure can comprise a filler or a combination of filler.

A filler can comprise, for example, inorganic filler, organic filler, low-density filler, conductive filler, or a combination of any of the foregoing.

A coating composition provided by the present disclosure can comprise, for example, from 0 wt % to 30 wt % filler, from 5 wt % to 25 wt % filler, from 7 wt % to 23 wt %, from 9 wt % to 21 wt %, from 11 wt % to 19 wt %, or from 13 wt % to 17 wt % filler, where wt % is based on the total solids weight of the coating composition. A coating composition provided by the present disclosure can comprise, for example, greater than 0 wt % filler, greater than 5 wt %, greater than 10 wt %, greater than 15 wt %, greater than 20 wt %, or greater than 25 wt % filler, where wt % is based on the total solids weight of the coating composition. A coating composition provided by the present disclosure can comprise, for example, less than 30 wt % filler, less than 25 wt %, less than 20 wt %, less than 15 wt %, less than 10 wt %, or less than 5 wt % filler, where wt % is based on the total solids weight of the coating composition.

A coating composition provided by the present disclosure can comprise an inorganic filler or combination of inorganic filler.

An inorganic filler can be included to provide mechanical reinforcement and to control the rheological properties of the coating composition. Inorganic filler may be added to compositions to impart desirable physical properties such as, for example, to increase the impact strength, to control the viscosity, or to modify the electrical properties of a cured composition.

Inorganic filler useful in a coating composition can include carbon black, calcium carbonate, precipitated calcium carbonate, calcium hydroxide, hydrated alumina (aluminum hydroxide), talc, mica, titanium dioxide, alumina silicate, carbonates, chalk, silicates, glass, metal oxides, graphite, silica, and combinations of any of the foregoing.

Examples of suitable silica include silica gel/amorphous silica, precipitated silica, fumed silica, and treated silica such as polydimethylsiloxane-treated silica. A coating composition provided by the present disclosure can comprise silica gel or combination of silica gel. Examples of suitable silica gel include Gasil® silica gel available from PQ Corporation, and Sylysia®, CariAct® and Sylomask® silica gel available from Fuji Silysia Chemical Ltd.

Examples of suitable calcium carbonate filler include products such as Socal® 31, Socal® 312, Socal® U1S1, Socal® UaS2, Socal® N2R, Winnofil® SPM, and Winnofil® SPT available from Solvay Special Chemicals. A calcium carbonate filler can include a combination of precipitated calcium carbonates.

A coating composition provided by the present disclosure can comprise a filler comprising a combination of silica and calcium carbonate.

Inorganic filler can be surface treated to provide hydrophobic or hydrophilic surfaces that can facilitate dispersion and/or compatibility of the inorganic filler with other components of a coating composition. An inorganic filler can include surface-modified particles such as, for example, surface modified silica. The surface of silica particles can be modified, for example, to be tailor the hydrophobicity or hydrophilicity of the surface of the silica particle. The surface modification can affect the dispersibility of the particles, the viscosity of the coating composition, the curing rate of the coating composition, and/or the adhesion of the coating composition.

A coating composition provided by the present disclosure can comprise, for example, from 10 wt % to 40 wt % of an inorganic filler, from 15 wt % to 35 wt %, or from 20 wt % to 30 wt % of an inorganic filler, where wt % is based on the total solids weight of the coating composition. A coating composition provided by the present disclosure can comprise, for example, greater than 10 wt % of an inorganic filler, greater than 15 wt %, greater than 20 wt %, greater than 25 wt %, greater than 30 wt %, or greater than 35 wt % of an inorganic filler, where wt % is based on the total solids weight of the coating composition. A coating composition provided by the present disclosure can comprise, for example, less than 40 wt % of an inorganic filler, less than 35 wt %, less than 30 wt %, less than 25 wt %, less than 20 wt %, or less than 15 wt % of an inorganic filler, where wt % is based on the total solids weight of the coating composition.

A coating composition provided by the present disclosure can comprise an organic filler or a combination of organic filler.

Organic filler can be selected to have a low specific gravity and to be resistant to solvents such as JRF Type I and/or to reduce the density of a coating layer. Suitable organic filler can also have acceptable adhesion to the sulfur-containing polymer matrix. An organic filler can include solid powders or particles, hollow powders or particles, or a combination thereof.

An organic filler can have a specific gravity, for example, less than 1.15, less than 1.1, less than 1.05, less than 1, less than 0.95, less than 0.9, less than 0.8, or less than 0.7. An organic filler can have a specific gravity, for example, within a range from 0.85 to 1.15, within a range from 0.9 to 1.1, within a range from 0.9 to 1.05, or from 0.85 to 1.05.

Organic filler can comprise a thermoplastic, a thermoset, or a combination thereof. Examples of suitable thermoplastics and thermosets include epoxies, epoxy-amides, ETFE copolymers, nylons, polyethylenes, polypropylenes, polyethylene oxides, polypropylene oxides, polyvinylidene chlorides, polyvinylfluorides, TFE, polyamides, polyimides, ethylene propylenes, perfluorohydrocarbons, fluoroethylenes, polycarbonates, polyetheretherketones, polyetherketones, polyphenylene oxides, polyphenylene sulfides, polystyrenes, polyvinyl chlorides, melamines, polyesters, phenolics, epichlorohydrins, fluorinated hydrocarbons, polycyclics, polybutadienes, polychloroprenes, polyisoprenes, polysulfides, polyurethanes, isobutylene isoprenes, silicones, styrene butadienes, liquid crystal polymers, and combinations of any of the foregoing. Organic filler can be provided in the form of solid particles.

Examples of suitable polyamide 6 and polyamide 12 particles are available from Toray Plastics as grades SP-500, SP-10, TR-1, and TR-2. Suitable polyamide powders are also available from the Arkema Group under the tradename Orgasol®, and from Evonik Industries under the tradename Vestosin®.

An organic filler can include a polyethylene powder, such as an oxidized polyethylene powder. Suitable polyethylene powders are available from Honeywell International, Inc. under the tradename ACumist®, from INEOS under the tradename Eltrex®, and Mitsui Chemicals America, Inc. under the tradename Mipelon®.

The use of organic filler such as polyphenylene sulfide in aerospace sealants is disclosed in U.S. Pat. No. 9,422,451. Polyphenylene sulfide is a thermoplastic engineering resin that exhibits dimensional stability, chemical resistance, and resistance to corrosive and high temperature environments. Polyphenylene sulfide engineering resins are commercially available, for example, under the tradenames Rytone® (Chevron), Techtron® (Quadrant), Fortron® (Celanese), and Torelina® (Toray). Polyphenylene sulfide resins are generally characterized by a specific gravity from about 1.3 to about 1.4.

A coating composition provided by the present disclosure can comprise a soft filler or combination of soft filler.

A soft filler can facilitate smoothing the surface of a cured coating by mechanical abrasion.

A soft filler refers to a filler having a hardness, for example, of less than 2.5 Mohs, less than 2.0 Mohs, or less than 1.5 Mohs.

Examples of suitable soft filler include come carbon black, kaolin, talc, gypsum, and combinations of any of the foregoing.

A coating composition provided by the present disclosure can comprise a low-density filler or a combination of low-density filler.

A low-density filler can include a low-density organic filler such as a modified, expanded thermoplastic microcapsules. Suitable modified expanded thermoplastic microcapsules can include an exterior coating of a melamine or urea/formaldehyde resin.

A coating composition can comprise low-density microcapsules. A low-density microcapsule can comprise a thermally expandable microcapsule.

Examples of suitable thermoplastic microcapsules include Expancel® microcapsules such as Expancel® DE microspheres available from AkzoNobel. Examples of suitable Expancel® DE microspheres include Expancel® 920 DE 40 and Expancel® 920 DE 80. Suitable low-density microcapsules are also available from Kureha Corporation.

Low-density filler such as low-density thermally expanded microcapsules can be characterized by a specific gravity within a range from 0.01 to 0.09, from 0.04 to 0.09, within a range from 0.04 to 0.08, within a range from 0.01 to 0.07, within a range from 0.02 to 0.06, within a range from 0.03 to 0.05, within a range from 0.05 to 0.09, from 0.06 to 0.09, or within a range from 0.07 to 0.09, wherein the specific gravity is determined according to ASTM D1475. Low-density filler such as low-density microcapsules can be characterized by a specific gravity less than 0.1, less than 0.09, less than 0.08, less than 0.07, less than 0.06, less than 0.05, less than 0.04, less than 0.03, or less than 0.02, wherein the specific gravity is determined according to ASTM D1475.

Low-density filler such as low microcapsules can be characterized by a mean particle diameter from 1 μm to 100 μm and can have a substantially spherical shape. Low-density filler such as low-density microcapsules can be characterized, for example, by a mean particle diameter from 10 μm to 100 μm, from 10 μm to 60 μm, from 10 μm to 40 μm, or from 10 μm to 30 μm, as determined according to ASTM D1475.

A low-density filler can comprise glass microspheres. For example, glass microspheres can have a bulk density, for example, from 0.1 g/cc to 0.5 g/cc and a particle size, for example, from 5 μm to 100 μm such as from 10 μm to 89 μm. Examples of suitable glass microspheres include glass bubbles available from 3M™ and hollow glass microspheres available from Potters Industries.

Low-density filler such as low-density microcapsules can comprise expanded microcapsules or microballoons having a coating of an aminoplast resin such as a melamine resin. Aminoplast resin-coated particles are described, for example, in U.S. Pat. No. 8,993,691. Such microcapsules can be formed by heating a microcapsule comprising a blowing agent surrounded by a thermoplastic shell. Uncoated low-density microcapsules can be reacted with an aminoplast resin such as a urea/formaldehyde resin to provide a coating of a thermoset resin on the outer surface of the low-density microcapsules.

A coating composition can comprise, for example, from 1 wt % to 90 wt % of low-density filler, from 1 wt % to 60 wt %, from 1 wt % to 40 wt %, from 1 wt % to 20 wt %, from 1 wt % to 10 wt %, or from 1 wt % to 5 wt % of low-density filler, where wt % is based on the total solids weight of the composition.

A coating composition can comprise, for example, greater than 1 wt % low-density filler, greater than 1 wt %, greater than 2 wt %, greater than 3 wt %, greater than 4 wt %, greater than 1 wt %, or greater than 10 wt % low-density filler, where wt % is based on the total solids weight of the coating composition.

A coating composition can comprise from 1 vol % to 90 vol % low-density filler, from 5 vol % to 70 vol %, from 10 vol % to 60 vol %, from 20 vol % to 50 vol %, or from 30 vol % to 40 vol % low-density filler, where vol % is based on the total solids volume of the coating composition.

A coating composition can comprise greater than 1 vol % low-density filler, greater than 5 vol %, greater than 10 vol %, greater than 20 vol %, greater than 30 vol %, greater than 40 vol %, greater than 50 vol %, greater than 60 vol %, greater than 70 vol %, or greater than 80 vol % low-density filler, where vol % is based on the total solids volume of the coating composition.

A coating composition provided by the present disclosure can comprise one or more colorants.

A coating composition provided by the present disclosure can comprise a pigment, a dye, a photochromic agent, or a combination of any of the foregoing.

Any suitable dye, pigment, and/or photochromic agent can be used.

Examples of suitable inorganic pigments include metal-containing inorganic pigments such as those containing cadmium, carbon, chromium, cobalt, copper, iron oxide, lead, mercury, titanium, tungsten, and zinc. Other suitable examples include ultramarine blue, ultramarine violet, reduced tungsten oxide, cobalt aluminate, cobalt phosphate, manganese ammonium pyrophosphate and/or metal-free inorganic pigments. In particular embodiments the inorganic pigment nanoparticles comprise ultramarine blue, ultramarine violet, Prussian blue, cobalt blue and/or reduced tungsten oxide. Examples of specific organic pigments include indanthrone, quinacridone, phthalocyanine blue, copper phthalocyanine blue, and perylene anthraquinone.

Additional examples of suitable pigments include iron oxide pigments, in all shades of yellow, brown, red and black; in all their physical forms and grain categories; titanium oxide pigments in all the different inorganic surface treatments; chromium oxide pigments also co-precipitated with nickel and nickel titanates; black pigments from organic combustion (e.g., carbon black); blue and green pigments derived from copper phthalocyanine, also chlorinated and brominated, in the various alpha, beta and epsilon crystalline forms; yellow pigments derived from lead sulphochromate; yellow pigments derived from lead bismuth vanadate; orange pigments derived from lead sulphochromate molybdate; yellow pigments of an organic nature based on arylamides; orange pigments of an organic nature based on naphthol; orange pigments of an organic nature based on diketo-pyrrolo-pyrrole; red pigments based on manganese salts of azo dyes; red pigments based on manganese salts of beta-oxynaphthoic acid; red organic quinacridone pigments; and red organic anthraquinone pigments.

A pigment can comprise titanium dioxide, carbon black, or a combination thereof.

A coating composition can comprise, for example, titanium dioxide, carbon black, or a combination thereof.

A coating composition can comprise, for example, from 0.1 wt % to 10 wt % of a colorant, from 1 wt % to 8 wt %, from 2 wt % to 6 wt %, or from 4 wt % to 6 wt % of a colorant, where wt % is based on the total solids weight of the coating composition. A coating composition can comprise, for example, greater than 0.1 wt %, greater than 1 wt %, greater than 2 wt %, greater than 4 wt %, greater than 6 wt %, or greater than 8 wt % of a colorant, where wt % is based on the total solids weight of the coating composition. A coating composition can comprise, for example, less than 10 wt % of a colorant, less than 8 wt %, less than 6 wt %, less than 4 wt %, less than 2 wt % or less than 1 wt % of a colorant, where wt % is based on the total solids weight of the coating composition.

A coating composition provided by the present disclosure can comprise a dispersant or combination of wetting agents/dispersants.

A dispersant can facilitate the suspension of particulates such as filler and pigments in the coating composition.

Examples of suitable dispersants include silicone-based agents, silicone-free agents such as acetylenic and alkoxylate derivatives, polymeric silicone-free agents such as acrylate or maleate derivatives, and fluoro-based agents.

A dispersant can be a high molecular weight block copolymer with pigment affinity groups.

A dispersant can comprise, for example, Disperbyk®-190 and Nuosperse® FX7500W.

A dispersant can include a salt of a carboxylic acid. Examples of suitable dispersants include Elka® FA dispersants available from BASF.

A coating composition provided by the present disclosure can comprise, for example, from 0.1 wt % to 5 wt % of a wetting agent/dispersant, from 0.5 wt % to 4 wt %, or from 1 wt % to 3 wt % of a dispersant, where wt % is based on the total solids weight of the coating composition. A coating composition provided by the present disclosure can comprise, for example, greater than 0.1 wt % of a dispersant, greater than 0.5 wt %, greater than 1 wt %, or greater than 3 wt % of a dispersant, where wt % is based on the total solids weight of the coating composition. A coating composition can comprise, for example, less than 5 wt %, less than 3 wt %, or less than 1 wt % of a dispersant, where wt % is based on the total solids weight of the coating composition.

A coating composition provided by the present disclosure can comprise a thickener or combination of thickeners.

Examples of suitable thickeners include polyether polyurethane resin solutions such as Rheolate® 288.

A coating composition can comprise, for example, less than 2 wt % of a thickener, less than 1 wt %, or less than 0.1 wt % of a thickener, where wt % is based on the total solids weight of the coating composition.

A coating composition provided by the present disclosure can comprise a defoamer or a combination of defoamers.

A defoamer can minimize the incorporation of air into a composition.

Examples of suitable defoamer include silicone-based defoamers, organic-based defoamers, and molecular-based defoamers, and combinations of any of the foregoing.

A defoamer can comprise a silicone-containing compound such as BYK@-022 available from BYK Chemie. Examples of suitable defoamers include FoamStar® products available from BASF.

A coating composition can comprise, for example, less than 2 wt % of a defoamer, less than 1.6 wt %, less than 1.2 wt %, or less than 0.8 wt % of a defoamer, where wt % is based on the total solids weight of the coating composition.

A coating composition provided by the present disclosure can comprise a leveling agent or a combination of leveling agents.

A leveling agent can facilitate the ability of a compositions to wet a surface.

Examples of suitable leveling agents include fluorochemical surfactants, polyacrylate-based surfactants and polysiloxane-based surfactants, and combinations of any of the foregoing.

A leveling agent can comprise a fluorocarbon-modified such as Hydropalat® products available from BASF and film-forming agents such as Loxanol® CA and Elka® PL products available from BASF.

A coating composition can comprise, for example, less than 1 wt % of a leveling agent, less than 0.8 wt %, less than 0.6 wt %, less than 0.4 wt %, or less than 0.2 wt % of a leveling agent, where wt % is based on the total solids weight of the coating composition.

A coating composition provided by the present disclosure can include an adhesion promoter or combination of adhesion promoters.

A coating composition provided by the present disclosure can comprise an adhesion promoter or combination of adhesion promoters. An adhesion promoter can include a phenolic adhesion promoter, a combination of phenolic adhesion promoters, an organo-functional silane, a combination of organo-functional silanes, or a combination of any of the foregoing. An organosilane can be an amine-functional silane.

A coating composition provided by the present disclosure can comprise a phenolic adhesion promoter, an organosilane, or a combination thereof. A phenolic adhesion promoter can comprise a cooked phenolic resin, an un-cooked phenolic resin, or a combination thereof. Examples of suitable phenolic adhesion promoters include phenolic resins such as Methylon® phenolic resin, and organosilanes, such as epoxy-, mercapto- or amine-functional silanes, such as Silquest® organosilanes.

Phenolic adhesion promoters can comprise the reaction product of a condensation reaction of a phenolic resin with one or more thiol-functional polysulfides. Phenolic adhesion promoters can be thiol functional.

Examples of suitable phenolic resins include 2-(hydroxymethyl)phenol, (4-hydroxy-1,3-phenylene)dimethanol, (2-hydroxybenzene-1,3,4-triyl) trimethanol, 2-benzyl-6-(hydroxymethyl)phenol, (4-hydroxy-5-((2-hydroxy-5-(hydroxymethyl)cyclohexa-2,4-dien-1-yl)methyl)-1,3-phenylene)dimethanol, (4-hydroxy-5-((2-hydroxy-3,5-bis(hydroxymethyl)cyclohexa-2,4-dien-1-yl)methyl)-1,3-phenylene)dimethanol, and a combination of any of the foregoing.

Suitable phenolic resins can be synthesized by the base-catalyzed reaction of phenol with formaldehyde.

Phenolic adhesion promoters can comprise the reaction product of a condensation reaction of a Methylon® resin, a Varcum® resin, or a Durez® resin available from Durez Corporation with a thiol-functional polysulfide such as a Thioplast® resin.

Examples of Methylon® resins include Methylon® 75108 (allyl ether of methylol phenol, see U.S. Pat. No. 3,517,082) and Methylon® 75202.

Examples of Varcum® resins include Varcum® 29101, Varcum® 29108, Varcum® 29112, Varcum® 29116, Varcum® 29008, Varcum® 29202, Varcum® 29401, Varcum® 29159, Varcum® 29181, Varcum® 92600, Varcum® 94635, Varcum® 94879, and Varcum® 94917.

An example of a Durez® resin is Durez® 34071.

A coating composition provided by the present disclosure can comprise an organo-functional adhesion promoter such as an organo-functional silane. An organo-functional silane can comprise hydrolysable groups bonded to a silicon atom and at least one organofunctional group. An organo-functional silane can have the structure R^{a}—(CH₂)ₙ—Si(—OR)₃₋ₙR^{b}ₙ, where RV is an organofunctional group, n is 0, 1, or 2, and R can be such as a C₁₋₁₂ alkyl or C₁₋₁₂ heteroalkyl, and R^{b} is can be C₁₋₄ alkyl such as methyl or ethyl. Examples of organofunctional groups include epoxy, amine, methacryloxy, or thiol groups. An organofunctional silane can be a dipodal silane having two or more silane groups, a functional dipodal silane, a non-functional dipodal silane or a combination of any of the foregoing. An organofunctional silane can be a combination of a monosilane and a dipodal silane.

An amine-functional silane can comprise a primary amine-functional silane, a secondary amine-functional silane, or a combination thereof. A primary amine-functional silane refers to a silane having primary amino group. A secondary amine-functional silane refers to a silane having a secondary amine group.

A secondary amine-functional silane can be a sterically hindered amine-functional silane. In a sterically hindered amine-functional silane the secondary amine can be proximate a large group or moiety that limits or restricts the degrees of freedom of the secondary amine compared to the degrees of freedom for a non-sterically hindered secondary amine. For example, in a sterically hindered secondary amine, the secondary amine can be proximate a phenyl group, a cyclohexyl group, or a branched alkyl group.

Amine-functional silanes can be monomeric amine-functional silanes having a molecular weight, for example, from 100 Daltons to 1,000 Daltons, from 100 Daltons to 800 Daltons, from 100 Daltons to 600 Daltons, or from 200 Daltons to 500 Daltons.

Examples of suitable primary amine-functional silanes include 4-aminobutyltriethoxy silane, 4-amino-3,3-dimethylbutyltrimethoxy silane, N-(2-aminoethyl)-3-aminopropyltriethoxy silane, 3(m-aminophenoxy)propyltrimethoxy silane, m-aminophenyltrimethoxy silane, p-aminophenyltrimethoxy silane, 3-aminopropyltriethoxy silane, 3-aminopropyltrimethoxysilane, 3-aminopropyltris(methoxyethoxyethoxy)silane, 11-aminoundecyltriethoxy silane, 2-(4-pyridylethyl)triethoxy silane, 2-(2-pyridylethyltrimethoxy silane, N-(3-trimethoxysilylpropyl)pyrrole, 3-aminopropylsilanetriol, 4-amino-3,3-dimethylbutylmethyldimethoxy silane, 3-aminopropylmethyldiethoxy silane, 1-amino-2-(dimethylethoxysilyl)propane, 3-aminopropyldiisopropyleneethoxy silane, and 3-aminopropyldimethylethoxy silane.

Examples of suitable diamine-functional silanes include aminoethylaminomethyl)phenethyltrimethoxy silane and N-(2-aminoethyl)-3-aminopropyltrimethoxysilane.

Examples of suitable secondary amine-functional silanes include 3-(N-allylamino)propyltrimethoxysilane, n-butylaminopropyltrimethoxy silane, tert-butylaminopropyltrimethoxy silane, (N,N-cylohexylaminomethyl)methyldiethoxy silane, (N-cyclohexylaminomethyl)triethoxy silane, (N-cyclohexylaminopropyl)trimethoxy silane, (3-(n-ethylamino)isobutyl)methyldiethoxy silane, (3-(N-ethylamino)isobutyl)trimethoxysilane, N-methylaminopropylmethyldimethoxy silane, N-methylaminopropyltrimethoxy silane, (phenylaminomethyl)methyldimethoxy silane, N-phenylaminomethyltriethoxy silane, and N-phenylaminopropyltrimethoxy silane.

Suitable amine-functional silanes are commercially available, for example, from Gelest Inc. and from Dow Corning Corporation.

An organo-functional adhesion promoter can comprise, for example, a mercapto-functional polyalkoxysilane, an epoxy-functional polyalkoxysilane, a hydroxy-functional alkoxysilane, an alkenyl-functional polyalkoxysilane, or an isocyanate-functional polyalkoxysilane.

An adhesion promoter can be a copolymerizable adhesion promoter. Copolymerizable adhesion promoters include adhesion promoters that have one or more functional groups reactive with one or more of the coreactants.

A coating composition provided by the present disclosure can comprise a reactive silane adhesion promoter. A reactive silane adhesion promoter refers to a compound having a polyalkoxysilane group and a group that is reactive with another constituent of the coating composition such as the difunctional polyepoxide, the aliphatic multifunctional polyepoxide, the polyepoxide-polyamine adduct, the aromatic/cycloaliphatic polyamine, and/or the polyacetoacetate. For example, the reactive group can comprise an epoxy group, an amine group, or thiol group.

A reactive silane adhesion promoter can comprise an epoxy-functional silane adhesion promoter, an amine-functional silane adhesion promoter, a thiol-functional adhesion promoter, or a combination of any of the foregoing.

Examples of suitable epoxy-functional adhesion promoters include Silquest® A-186, Silquest® A-187, Silquest® A-1871, and Silquest® Wetlink 78 available from Momentive Performance Materials, and Dowsil@ Z-6040 available from Dow Corning.

Examples of suitable amine-functional adhesion promoters include Silquest® A-1120, Silquest® A-1130, Silquest® A-1170, and Silquest® A-1100 available from Momentive Performance Materials and XIAMETER@ OFS-6011 and XIAMETER@ OFS-6020 available from Dow Corning.

Examples of suitable thiol-functional adhesion promoters include Silquest@ A-189 from Momentive Performance Materials.

A coating composition provided by the present disclosure can comprise, for example, from 0.3 wt % to 3.0 wt % of an adhesion promoter, from 0.5 wt % to 2.5 wt %, or from 1 wt % to 2 wt % of an adhesion promoter, where wt % is based on the total solids weight of the coating composition.

A coating composition can comprise, for example, greater than 0.3 wt %, greater than 0.5 wt %, greater than 1.0 wt %, greater than 1.5 wt %, greater than 2.0 wt %, or greater than 2.5 wt % of an adhesion promoter, where wt % is based on the total solids weight of the coating composition.

A coating composition can comprise, for example, less than 3.0 wt %, less than 2.5 wt %, less than 2.0 wt %, less than 1.5 wt % or less than 1.0 wt % of an adhesion promoter, where wt % is based on the total solids weight of the coating composition.

A composition provided by the present disclosure can comprise a corrosion inhibitor or combination of corrosion inhibitors.

Examples of suitable corrosion inhibitors include, for example, zinc phosphate-based corrosion inhibitors, a lithium silicate corrosion inhibitor such as lithium orthosilicate (Li₄SiO₄) and lithium metasilicate (Li₂SiO₃), magnesium oxide, an azole, a monomeric amino acid, a dimeric amino acid, an oligomeric amino acid, a nitrogen-containing heterocyclic compound such as an azole, oxazole, thiazole, thiazolines, imidazole, diazole, pyridine, indolizine, and triazine, tetrazole, and/or tolyltriazole, corrosion resistant particles such as inorganic oxide particles, including for example, zinc oxide (ZnO), magnesium oxide (MgO), cerium oxide (CeO₂), molybdenum oxide (MoO₃), and/or silicon dioxide (SiO₂), and combinations of any of the foregoing.

A coating composition provided by the present disclosure can comprise a rare earth corrosion inhibitor, a calcium sulfate corrosion inhibitor, or a combination thereof.

Examples of suitable rare earth corrosion inhibitors include, for example, yttrium oxides, lanthanum oxides, cerium oxides, and praseodymium oxides.

Examples of suitable calcium sulfate corrosion inhibitors include, for example, calcium sulfate anhydride and gypsum.

A coating composition provided by the present disclosure can comprise, for example, from 25 wt % to 45 wt % of a corrosion inhibitor, from 28 wt % to 42 wt %, from 30 wt % to 40 wt %, or from 32 wt % to 38 wt % of a corrosion inhibitor, where wt % is based on the total solids weight of the coating composition.

A coating composition provided by the present discloser can comprise, for example, greater than 25 wt % of a corrosion inhibitor, greater than 30 wt %, greater than 35 wt %, or greater than 40 wt % of a corrosion inhibitor, where wt % is based on the total solids weight of the composition.

A coating composing provided by the present disclosure can comprise, for example, less than 45 wt % of a corrosion inhibitor, less than 40 wt %, less than 35 wt %, or less than 30 wt % of a corrosion inhibitor, where wt % is based on the total solids weight of the composition.

A coating composition provided by the present disclosure can comprise, for example, from 0.05 wt % to 0.45 wt % of a dispersing agent; from 8 wt % to 18 wt % of an inorganic filler; from 0.1 to 1.6 wt % of a colorant; from 20 wt % to 50 wt % of a corrosion inhibitor; and from 0.05 wt % to 1.5 wt % of an adhesion promoter, wherein wt % is based on the total solids weight of the coating composition.

A coating composition provided by the present disclosure can comprise, for example, from 0.15 wt % to 0.35 wt % of a dispersing agent; from 11 wt % to 16 wt % of an inorganic filler; from 0.5 to 1.3 wt % of a colorant; from 25 wt % to 45 wt % of a corrosion inhibitor; and from 0.35 wt % to 1.1.5 wt % of an adhesion promoter, wherein wt % is based on the total solids weight of the coating composition.

A coating composition provided by the present disclosure can comprise a solvent or a combination of solvents.

A solvent can comprise water and an organic solvent or combination of organic solvents.

A solvent can be included in the coating composition to adjust the viscosity of the coating composition as appropriate for and method of application.

A coating composition provided by the present disclosure can comprise water.

A coating composition provided by the present disclosure can comprise, for example, from 30 wt % to 60 wt % water, from 35 wt % to 55 wt %, or from 40 wt % to 50 wt % water, where wt % is based on the total weight of the coating composition.

A coating composition provided by the present disclosure can comprise, for example, greater than 30 wt % water, greater than 35 wt %, greater than 40 wt %, greater than 45 wt %, or greater than 50 wt % water, where wt % is based on the total weight of the coating composition.

A coating composition provided by the present disclosure can comprise, for example, less than 60 wt % water, less than 55 wt %, less than 50 wt %, less than 45 wt %, less than 40 wt %, or less than 35 wt % water, where wt % is based on the total weight of the coating composition.

A coating composition provided by the present disclosure can comprise, for example, a dispersing agent, an inorganic filler, a colorant, a corrosion inhibitor, and an adhesion promoter.

A coating composition provided by the present disclosure can comprise an organic solvent or a combination of organic solvents.

An organic solvent can comprise, for example, a combination of a nitro paraffin and an alcohol.

An organic solvent can be selected to readily evaporate from a thin film of the coating composition at 25° C. Nitro paraffins can render modified polyamine resins water reducible by water by forming a complex with the modified polyamine resin.

A nitro paraffin can have a molecular weight, for example, less than 250 Daltons, less than 200 Daltons, or less than 150 Daltons.

A nitro paraffin can have the structure of Formula (3):

CR₃(CR₂)ₙ—CR₃ (3)

where n is an integer from 1 to 4 and each R is independently selected from hydrogen, Cl, and —NO₂, where from 1 to 2 of the R groups are —NO₂.

In a nitro paraffin of Formula (3), n can be 1, 2, 3, or 4.

In a nitro paraffin of Formula (3) each R can independently be selected from hydrogen and —NO₂ wherein from 1 or 2 of the X groups is —NO₂.

A nitro paraffin can comprise, for example, nitromethane, nitroethane, 1-nitropropane, 2-nitropropane, 1-nitrobutane, 2-nitrobutane, 1,3 di-nitropropane, 1-chloro-nitropropane, or a combination of any of the foregoing.

A nitro paraffin can comprise nitroethane.

An alcohol can comprise, for example, 2-butanol, 1-butanol, 2-propanol, 1-propanol, or a combination of any of the foregoing.

A coating composition provided by the present disclosure can comprise, for example from 5 wt % to 25 wt % of an organic solvent, from 7.5 wt % to 22.5 wt %, or from 10 wt % to 20 wt % of an organic solvent, where wt % is based on the total weight of the coating composition.

A coating composition provided by the present disclosure can comprise, for example, greater than 5 wt % of an organic solvent, greater than 10 wt %, greater than 15 wt %, or greater than 20 wt % of an organic solvent, where wt % is based on the total weight of the coating composition.

A coating composition provided by the present disclosure can comprise, for example, less than 25 wt % of an organic solvent, less than 20 wt %, less than 15 wt %, or less than 10 wt % of an organic solvent, where wt % is based on the total weight of the coating composition.

A coating composition provided by the present disclosure can be a sprayable coating composition.

A sprayable coating composition provided by the present disclosure can comprise, for example, from 30 wt % to 60 wt % water, from 35 wt % to 55 wt %, or from 40 wt % to 50 wt % water, where wt % is based on the total weight of the sprayable coating composition.

A sprayable coating composition can comprise, for example, greater than 30 wt % water, greater than 35 wt %, greater than 40 wt %, greater than 45 wt %, or greater than 50 wt % water, where wt % is based on the total weight of the sprayable coating composition.

A sprayable coating composition can comprise, for example, less than 60 wt % water, less than 55 wt %, less than 50 wt %, less than 45 wt %, less than 40 wt %, or less than 35 wt % water, where wt % is based on the total weight of the sprayable coating composition.

A sprayable coating composition can comprise, for example, from 5 wt % to 20 wt % organic solvent, from 7.5 wt % to 17.5 wt %, or from 10 wt % to 15 wt % of an organic solvent, where wt % is based on the total weight of the sprayable coating composition.

A sprayable coating composition can comprise, for example, greater than 5 wt % organic solvent, greater than 7 wt %, greater than 8 wt %, greater than 11 wt %, greater than 13 wt %, greater than 15 wt %, or greater than 17 wt % organic solvent, where wt % is based on the total weight of the sprayable coating composition.

A sprayable coating composition can comprise, for example, less than 20 wt % organic solvent, less than 17.5 wt %, less than 15 wt %, less than 12.5 wt %, or less than 10 wt % organic solvent, where wt % is based on the total weight of the sprayable coating composition.

A coating composition, such as a sprayable coating composition, provided by the present disclosure can have a VOC, for example, from 50 g/L to 350 g/L, from 50 g/L to 300 g/L, or from 100 g/L to 250 g/L.

A coating composition provided by the present disclosure can have a VOC, for example, greater than 50 g/L, greater than 100 g/L, greater than 150 g/L, greater than 200 g/L, or greater than 250.

A coating composition provided by the present disclosure can have a VOC, for example, less than 350 g/L, less than 300 g/L, less than 250 g/L, less than 200 g/L, less than 150 g/L, or less than 100 g/L.

A coating composition provided by the present disclosure can have a pot life, for example, of from 4 hours to 8 hours, from 4 hours to 7 hours, from 4 hours to 6 hours, or from 4 hours to 5 hours, where pot life is determined by measuring the viscosity according to ASTM D1200.

A coating composition provided by the present disclosure can have a drying time at 25° C./50% RH of from 1 hours to 4 hours, such as from 2 to 3 hours, where the drying time is determined according to ASTM D5895.

A coating composition provided by the present disclosure can have a drying time at 25° C./50% RH of less than 4 hours, less than 3 hours, or less than 1 hour, where the drying time is determined according to ASTM D5895.

A coating composition provided by the present disclosure can be a sprayable coating composition and can have a viscosity, for example, from 20 Pa·sec to 40 Pa·sec as measured using a Ford Cup #4 according to ASTM D1200.

A coating composition provided by the present disclosure can have any suitable viscosity. The viscosity can be, for example, suitable for use as a spreadable or extrudable composition. The viscosity of a coating composition provided by the present disclosure can be adjusted as desired by the addition of solvent.

A coating composition provided by the present disclosure can be sprayable. A sprayable composition can have a viscosity, for example, from 1 poise to 200 poise (0.1 Pa·sec to 20 Pa·sec), from 20 poise to 200 poise (2 Pa·sec to 20 Pa·sec), from 20 poise to 100 poise (2 Pa·sec to 10 Pa·sec), from 20 poise to 80 poise (2 Pa·sec to 8 Pa·sec), or from 30 poise to 60 poise (2 Pa·sec to 6 Pa·sec), or less than 100 poise (10 Pa·sec).

A coating composition provided by the present disclosure can be prepared from a multicomponent coating system by combining and mixing a polyepoxide component and a polyamine component, and as appropriate a solvent.

A multicomponent coating system provided by the present disclosure can comprise a polyepoxide component and a polyamine component.

At the time of application, the polyepoxide component and the polyamine component can be combined and mixed to form a coating composition, which can be applied to a surface.

For a sprayable coating composition, at the time of application, the polyepoxide component, the polyamine component, and water can be combined and mixed to form a sprayable coating composition, which can be applied to a surface.

A multicomponent system can be provided to a user as separate components such as a polyepoxide component, a polyamine component, and a solvent or water component. The separate components can be provided in separate cans or containers, which are combined and mixed prior to application.

A polyamine component provided by the present disclosure can comprise, for example, a polyepoxy-polyamine adduct and an aromatic/cycloaliphatic polyamine.

A polyamine component provided by the present disclosure can comprise, for example, from 90 wt % to 99.9 wt % of a polyepoxy-polyamine adduct; and from 0.5 wt % to 10 wt % of an aromatic/cycloaliphatic polyamine, wherein wt % is based on the weight of the polyepoxy-polyamine adduct and the aromatic/cycloaliphatic polyamine.

A polyamine component can comprise, for example, from 25 wt % to 55 wt % of a polyepoxy-polyamine adduct, from 30 wt % to 50 wt % or from 35 wt % to 45 wt % of a polyepoxy-polyamine adduct, where wt % is based on the total weight of the polyamine component.

A polyamine component can comprise, for example, greater than 25 wt %, greater than 30 wt %, greater than 35 wt %, greater than 40 wt %, greater than 45 wt %, or greater than 50 wt % of the polyepoxy-polyamine adduct, where wt % is based on the total weight of the polyamine component.

A polyamine component can comprise, for example, less than 55 wt %, less than 50 wt %, less than 45 wt %, less than 40 wt %, less than 35 wt %, or less than 30 wt % of the polyepoxy-polyamine adduct, where wt % is based on the total weight of the polyamine component.

A polyamine component can comprise, for example from 0.1 wt % to 3 wt % of the aromatic/cycloaliphatic polyamine, from 0.2 wt % to 2.0 wt %, from 0.3 wt % to 1.0 wt %, or from 0.4 wt % to 0.8 wt % of the aromatic/cycloaliphatic polyamine, where wt % is based on the total weight of the polyamine component.

A polyamine component can comprise, for example, less than 3.0 wt %, less than 2.0 wt %, less than 1.0 wt %, or less than 0.5 wt % of an aromatic/cycloaliphatic polyamine, where wt % is based on the total weight of the polyamine component.

A polyamine component can comprise, for example, greater than 0.1 wt %, greater than 0.5 wt %, greater than 1.0 wt %, or greater than 2.0 wt % of the aromatic/cycloaliphatic polyamine, where wt % is based on the total weight of the polyamine component.

A polyamine component provided by the present disclosure can comprise, for example, from 25 wt % to 55 wt % of the polyepoxy-polyamine adduct; and from 0.1 wt % to 3.0 wt % of the aromatic/cycloaliphatic polyamine; wherein wt % is based on the total weight of the polyamine component.

A polyamine component provided by the present disclosure can comprise, for example, in addition to the polyepoxy-polyamine adduct and the aromatic/cycloaliphatic polyamine, a dispersing agent, an inorganic filler, a pigment, a corrosion inhibitor, an organic solvent, or a combination of any of the foregoing.

For example, a polyamine component can comprise from 5 wt % to 25 wt % of an inorganic filler; less than 2 wt % of a dispersing agent; less than 2 wt % of a pigment; from 30 wt % to 50 wt % of a corrosion inhibitor; and from 3 wt % to 10 wt % of an organic solvent, where wt % is based on the total weight of the polyamine component.

A polyepoxide component can comprise, for example, a difunctional polyepoxide, an aliphatic multifunctional polyepoxide, and a polyacetoacetate resin.

A polyepoxide component can comprise, for example, from 60 wt % to 98 wt % of a difunctional polyepoxide, from 1 wt % to 20 wt % of an aliphatic multifunctional polyepoxide, and from 1 wt % to 20 wt % of a polyacetoacetate resin, where wt % is based on the total weight of the difunctional polyepoxide, the aliphatic multifunctional polyepoxide, and the polyacetoacetate resin.

A polyepoxide component can comprise, for example, from 35 wt % to 75 wt % of a difunctional polyepoxide, from 30 wt % to 70 wt %, from 35 wt % to 65 wt %, or from 40 wt % to 60 wt % of a difunctional polyepoxide, where wt % is based on the total weight of the polyepoxide component.

A polyepoxide component can comprise, for example, from 1 wt % to 9 wt % of an aliphatic multifunctional polyepoxide, from 2 wt % to 8 wt %, from 3 wt % to 7 wt %, or from 4 wt % to 6 wt % of an aliphatic multifunctional polyepoxide, where wt % is based on the total weight of the polyepoxide component.

A polyepoxide component can comprise, for example, from 0.5 wt % to 5.5 wt % of a polyacetoacetate resin, from 1 wt % to 5 wt %, from 1.5 wt % to 4.5 wt %, or from 2 wt % to 4 wt % of a polyacetoacetate resin, where wt % is based on the total weight of the polyepoxide component.

A polyepoxide component can comprise, for example, from 35 wt % to 75 wt % of a difunctional polyepoxide; from 1 wt % to 9 wt % of an aliphatic multifunctional polyepoxide; and from 0.5 wt % to 5.5 wt % of a polyacetoacetate resin, where wt % is based on the total weight of the polyepoxide component.

A polyepoxide component can comprise, for example, from 40 wt % to 70 wt % of a difunctional polyepoxide; from 3 wt % to 7 wt % of an aliphatic multifunctional polyepoxide; and from 1 wt % to 4 wt % of a polyacetoacetate resin, where wt % is based on the total weight of the polyepoxide component.

In addition to a difunctional polyepoxide, a multifunctional polyepoxide, and a polyacetoacetate resin, the polyepoxide component can comprise an adhesion promoter and an organic solvent such as a nitro paraffin.

For example, a polyepoxide component can further comprise, for example, from 0.5 wt % to 5 wt % of an adhesion promoter; and from 20 wt % to 50 wt % of an organic solvent such as a nitro paraffin, where wt % is based on the total weight of the polyepoxide component.

For example, a polyepoxide component can further comprise, for example, from 0.5 wt % to 3 wt % of an adhesion promoter; and from 25 wt % to 45 wt % of an organic solvent such as a nitro paraffin, where wt % is based on the total weight of the polyepoxide component.

At the time of application from 80 parts to 120 parts of the polyamine component can be combined with from 30 parts to 50 parts of the polyepoxide component to provide a coating composition provided by the present disclosure.

For a sprayable coating composition, in addition to the polyamine component and the polyepoxide component, from 100 parts to 140 parts of water can be added to provide a sprayable coating composition.

A coating composition provided by the present disclosure can be used to provide a cured coating.

A cured coating provided by the present disclosure can serve as a primer coating, as an interlayer coating, and/or as a topcoat.

A coating composition can be applied to a surface using any suitable method such as by extruding, roller coating, spreading, brushing, or spraying.

A coating composition can be applied to a surface manually or robotically.

A coating composition can be applied to a surface using a suitable additive manufacturing method such as a coreactive additive manufacturing concluding, for example, three-dimensional printing. In coreactive additive manufacturing the polyamine component and the polyepoxy component can be combined and mixed to form a coreactive coating composition provided the present disclosure and extruded or ejected from a single nozzle onto a surface or a previously deposited layer of the coreactive coating composition. Coreactive additive manufacturing includes forming multilayer or multicomponent extrudates and depositing the multilayer.

A coating composition provided by the present disclosure can be applied to a surface to provide a coating having a wet thickness, for example, less than 4 mils (101.6 μm), less than 3 mils (76.2 μm), less than 2 mils (50.8 μm), or less than 1 mil (25.4 μm).

A coating composition provided by the present disclosure can be applied to a surface to provide a coating having a dry thickness, for example, less than 2 mils (50.8 μm), less than 1 mils (25.4 μm), or less than 0.5 mils (12.7 μm).

A sprayable coating composition provided by the present disclosure can be applied to any suitable substrate.

For example, a sprayable coating composition can be applied to a metal surface, a treated metal surface, a primer coating, or a polymeric coating.

A composition provided by the present disclosure may be applied to any suitable substrate. Examples of suitable substrates to which a composition may be applied include metals such as titanium, stainless steel, steel alloy, aluminum, and aluminum alloy, any of which may be anodized, primed, organic-coated or chromate-coated; epoxy; urethane; graphite; fiberglass composite; Kevlar®; acrylics; and polycarbonates.

A coating composition provided by the present disclosure may be applied to a substrate such as aluminum and aluminum alloy.

A metal surface can be treated, for example, chemical conversion coating or an anodizing coating.

A substrate can be an aerospace substrate. Examples of aerospace substrates include stainless steel AMS 5513, sulfuric acid anodized aluminum AMS 2471, titanium composition C AMS 4911, Alclad 2024 T3 aluminum QQA 250/5, CA8000 polyurethane, abraded CA8000 polyurethane, PR205 epoxy primer, aluminum QQA 250/12, aluminum QQA 250/13, AMS-C-27725 primer, MIL-PRF-23377 epoxy primer, and Alodine® 1200.

A polymeric coating can overlie an applied coating provided by the present disclosure. The overlying coating can be a polyurethane coating, such as a polyurethane topcoat.

After a coating composition is applied to a substrate, the coating composition can be cured. An applied coating provided by the present disclosure can cure, for example, in 7 days at 25° C. A fully cured coating exhibits a hardness that is within 10% of the maximum hardness of the coating. A full cure can develop over several weeks or months at 25° C., and the curing time can be accelerated upon exposure to elevated temperatures such as at temperature greater than 25° C.

A partially cured coating refers to an applied coating that has not fully cured. A partially cured coating can have a hardness that is less than 10% of the maximum hardness of a fully cured coating. A partially cured coating can have reactive functional groups capable of chemically bonding to reciprocal reactive functional groups of compounds in an overlying layer such as an overlying polyurethane topcoat. A partially cured coating can refer to a coating provided by the present disclosure that is exposed to a temperature of 25° C. for less than 1 day following application, less than 2 days, less than 3 days, less than 4 days, or less than 5 days after forming the applied coating.

A cured coating provided by the present disclosure can exhibit a scratch resistance of greater than 1,000 grams following immersion in a phosphate ester-based aviation fluid such as a Skydrol® fluid for 1,000 hours at 70° C. as determined according to ISO 1518.

A cured coating provided by the present disclosure can exhibit adhesion to an aluminum substrate following immersion in water for 24 hours at 140° F. (60° C.) as determined according to ASTM D3359 with a rating of 4B or 5B.

A cured coating provided by the present disclosure can exhibit a hardness of at least 3H as determined according to ASTM D3363.

A cured coating provided by the present disclosure can exhibit solvent resistance with respect to phosphate-based ester hydraulic fluids as determined according to ASTM D5402.

A cured coating provided by the present disclosure can have a dry film thickness of less than 2 mils (51 μm).

A cured coating provided by the present disclosure exhibits a scratch resistance of 1,200 grams following immersion in Skydrol® LD-4 for 1,000 hours at 70° C. as determined according to ISO 1518.

A cured coating provided by the present disclosure exhibits an adhesion of 5B to a polyurethane topcoat following water immersion as determined according to ASTM D3359.

Multilayer coatings provided by the present disclosure can be chemically resistant.

Chemical resistance refers to the ability of a material such as a coating to minimize the diffusion of relevant gases and liquids through the coating such that exposure of the coating to relevant gases and liquids during the design life of the material under use conditions will not decrease the physical properties of the material below a certain threshold. The relevant gases and solvents, use conditions, product life, and threshold physical properties can depend on the specific use application. Examples of relevant solvents include high temperature gases, high temperature water, salt water, salt spray, cleaning solvents, greases, fuels, hydraulic fluids, oils, and lubricants.

Chemical resistance can be determined by measuring the % swell following immersion of a coating in a particular solvent for 7 days at a temperature of 70° C. A chemically resistant material can exhibit a % swell less than 25%, less than 20%, less than 15%, or less than 10%, following immersion in a chemical for 7 days at 70° C., where % swell is determined according to EN ISO 10563.

Other chemical resistance tests can be application specific. For example, for certain aerospace sealant applications, following exposure to Jet Reference Fluid (JRF Type 1) according to ISO 1817 for 168 hours at 60° C., a cured composition provided can exhibit a tensile strength greater than 1.4 MPa determined according to ISO 37, a tensile elongation greater than 150% determined according to ISO 37, and a hardness greater than Shore 30 A determined according to ISO 868, where the tests are performed at a temperature of 23° C., and a humidity of 55% RH. Following exposure to de-icing fluid according to ISO 11075 Type 1 for 168 hours at 60° C., a cured composition can exhibit a tensile strength greater than 1 MPa determined according to ISO 37, and a tensile elongation greater than 150% determined according to ISO 37, where the tests are performed at a temperature of 23° C., and a humidity of 55% RH. Following exposure to phosphate ester hydraulic fluid such as Skydrol® LD-4 for 1,000 hours at 70° C., a cured composition can exhibit a tensile strength greater than 1 MPa determined according to ISO 37, a tensile elongation greater than 150% determined according to ISO 37, and a hardness greater than Shore 30 A determined according to ISO 868, where the tests are performed at a temperature of 23° C., and a humidity of 55% RH.

For aerospace applications important properties include chemical resistance such as resistance to fuels, hydraulic fluids, oils, greases, lubricants and solvents, low temperature flexibility, high temperature resistance, ability to dissipate electrical charge, and dielectric breakdown strength.

A multilayer coating provided by the present disclosure can comprise a water-reducible coating provided by the present disclosure and an underlying coating, an overlying coating, or both an underlying coating and an overlying coating.

For example, a multilayer coating provided by the present disclosure can comprise a coating provided by the present disclosure that serves as a primer coating and can directly overlying a substrate such as an aerospace substrate, and an overlying coating such as a polyurethane topcoat.

For example, a multilayer coting provided by the present disclosure can serve as an interlayer coating that overlies a first coating and underling as second coating.

For example, in a multilayer coating, a water-reducible coating can be an exterior coating and can overlie one or more coatings.

A coating composition provided by the present disclosure can be used to level surfaces, to enhance adhesion between a substrate such as a polymer substrate and an overlying coating, and/or to enhance adhesion between two coatings.

A coating composition provided by the present disclosure can be used on a surface of any suitable part. Examples of suitable parts include vehicle parts, architectural parts, construction parts, electronic parts, furniture, medical devices, portable devices, telecommunications devices, athletic equipment, apparel, and toys.

Parts such as vehicle parts including construction equipment parts, heavy machinery parts, construction equipment parts, automotive vehicle parts and aerospace vehicle parts made using additive manufacturing such as three-dimensional printing.

A coating composition provided by the present disclosure can be used to coat internal and external vehicle parts such as motor vehicle parts, railed vehicle parts, aerospace vehicle parts, military vehicle parts, and watercraft parts.

Any suitable vehicle part can be coated using a coating composition provided by the present disclosure.

A vehicle part can be a new part or a replacement part.

The term “vehicle” is used in its broadest sense and includes all types of aircraft, spacecraft, watercraft, and ground vehicles. For example, a vehicle can include aircraft such as airplanes including private aircraft, and small, medium, or large commercial passenger, freight, and military aircraft; helicopters, including private, commercial, and military helicopters; aerospace vehicles including, rockets and other spacecraft. A vehicle can include a ground vehicle such as, for example, trailers, cars, trucks, buses, vans, construction vehicles, golf carts, motorcycles, bicycles, scooters, trains, and railroad cars. A vehicle can also include watercraft such as, for example, ships, boats, and hovercraft.

A vehicle part can be, for example, part for a motor vehicle, including automobile, truck, bus, van, motorcycles, scooters, and recreational motor vehicles; railed vehicles including trains and trams; bicycles; aerospace vehicles including airplanes, rockets, spacecraft, jets, and helicopters; military vehicles including jeeps, transports, combat support vehicles, personnel carriers, infantry fighting vehicles, mine-protected vehicles, light armored vehicles, light utility vehicles, and military trucks; and watercraft including ships, boats, and recreational watercraft.

Examples of aviation vehicles include F/A-18 jet or related aircraft such as the F/A-18E Super Hornet and F/A-18F; in the Boeing 787 Dreamliner, 737, 747, 717 passenger jet aircraft, a related aircraft (produced by Boeing Commercial Airplanes); in the V-22 Osprey; VH-92, S-92, and related aircraft (produced by NAVAIR and Sikorsky); in the G650, G600, G550, G500, G450, and related aircraft (produced by Gulfstream); and in the A350, A320, A330, and related aircraft (produced by Airbus). Methods provided by the present disclosure can be used in any suitable commercial, military, or general aviation aircraft such as, for example, those produced by Bombardier Inc. and/or Bombardier Aerospace such as the Canadair Regional Jet (CRJ) and related aircraft; produced by Lockheed Martin such as the F-22 Raptor, the F-35 Lightning, and related aircraft; produced by Northrop Grumman such as the B-2 Spirit and related aircraft; produced by Pilatus Aircraft Ltd.; produced by Eclipse Aviation Corporation; or produced by Eclipse Aerospace (Kestrel Aircraft).

A vehicle part can be an interior vehicle part or an exterior vehicle part.

A vehicle can comprise a motor vehicle and the motor vehicle part can comprise a hood, door, side panel, bumper, roof, wheel well, dashboard, seat, trunk, handle, floor, chassis, cabin, chassis, cargo bed, steering wheel, fuel tank, engine block, trim, bumper, and/or a battery casing.

A vehicle can comprise a railed vehicle and the railed vehicle part can comprise an engine and/or a rail car.

A vehicle can comprise an aerospace vehicle and the aerospace part can comprise a cockpit, fuselage, wing, aileron, tail, door, seat, interior panel, fuel tank, interior panel, flooring, and/or frame.

A vehicle can comprise a military vehicle and the military vehicle part can comprise a hood, door, side panel, bumper, roof, wheel well, dashboard, seat, trunk, handle, floor, chassis, cabin, chassis, cargo bed, steering wheel, fuel tank, engine block, trim, bumper, a mount, a turret, an undercarriage, and/or a battery casing.

A vehicle can comprise a watercraft and the watercraft part can comprise a hull, an engine mount, a seat, a handle, a chassis, a battery, a battery mount, a fuel tank, an interior accessory, flooring, and/or paneling.

A vehicle part coated using a coating composition provided by the present disclosure can have properties for the intended purpose. For example, an automotive part can be designed have a light weight. An external part for military vehicle can be designed to have a high impact strength.

A part for a commercial aerospace vehicle can be designed to have a light weight and/or to be static dissipative. An external part for a military aircraft can be designed to exhibit RFI/EMI shielding properties.

A coating composition provided by the present disclosure can be adapted to coat custom designed vehicle parts, replacement parts, upgraded parts, specialty parts, and/or high-performance parts rapidly and cost-effectively in low volume production.

An aspect of the invention includes parts comprising a coating provided by the present disclosure.

### EXAMPLES

Embodiments provided by the present disclosure are further illustrated by reference to the following examples, which describe the coating compositions provided by the present disclosure, uses of the compositions, and properties of coatings prepared using the coating compositions. It will be apparent to those skilled in the art that many modifications, both to materials and methods, may be practiced without departing from the scope of the disclosure.

### Example 1

### Sprayable Coating Compositions

Sprayable coating compositions provided by the present disclosure were prepared by combining and mixing a base component (polyamine component), an activator (polyepoxide) component, and water.

The constituents of the base component and the activator component for the sprayable coating compositions are listed in Tables 1 and 2, respectively.

TABLE 1
Base, polyamine component.

| Constituent | Amount (wt %) |
|---|---|
| Polyepoxide-polyamine adduct | 38.22 |
| Aromatic/cycloaliphatic polyamine | 0.60 |
| Dispersing agent | 0.49 |
| Pigment (titanium dioxide) | 14.08 |
| Color pigment | 0.94 |
| Rare earth corrosion inhibitor | 15.65 |
| Calcium sulfate corrosion inhibitor | 23.47 |
| Alcohol (organic solvent) | 6.56 |
| Total Base Component | 100.00 |

TABLE 2
Activator, polyepoxide component.

| Constituent | Amount (wt %) |
|---|---|
| Difunctional polyepoxide | 57.00 |
| Polyacetoacetate resin | 3.13 |
| Nitro paraffin | 32.88 |
| (organic solvent) | |
| Aliphatic multifunctional | 4.73 |
| aliphatic polyepoxide | |
| Adhesion promoter | 1.95 |
| Stabilizer | 0.30 |
| Total Activator Component | 100.00 |

The base component and the activator component were combined in a ratio of 100 parts base component to 40 parts activator component and combined with 120 parts water to provide a sprayable coating composition. The amount of the solids, volatile organic, and water in the admixture and coating composition are provided in Table 3.

TABLE 3
Amounts of solids and solvent.

| | | Amount (wt) |
|---|---|---|
| ¹ NVM | ³ Admixture - | 105.2 |
| | Base/Activator | |
| ² VOC (alcohol) | Admixture - | 34.8 |
| | Base/Activator | |
| Water | Admixture - | 120.0 |
| | Organic Solvent | |
| Total | Coasting Composition - | 260.0 |
| | Base/Activator/Water | |
| Total | Coasting Composition - | 46.15% |
| | Water | |

¹ Non-volatile material.
² Volatile organic content.
³ Admixture refers to the composition of the base and activator components before the addition of water.

### Example 2

### Comparative and Inventive Coating Compositions

Sprayable coating compositions were prepared having different amounts of the aromatic/cycloaliphatic polyamine and the polyacetoacetate resin. The solid constituents of the sprayable coating compositions are presented in Table 4.

TABLE 4
Sprayable coating compositions.

| | | | | |
|---|---|---|---|---|
| | Comparative | Comparative | Comparative | Inventive |
| | Coating A | Coating B | Coating C | Coating |
| Constituent | (wt %) | (wt %) | (wt %) | (wt %) |

Base Component

| | | | | |
|---|---|---|---|---|
| Polyepoxy-polyamine adduct | 22.8 | 27.3 | 27.3 | 27.3 |
| Aromatic/cycloaliphatic | 0 | 0.4 | 0.4 | 0.4 |
| polyamine | | | | |
| Pigments | 9.8 | 10.8 | 10.8 | 10.8 |
| Corrosion inhibitors | 33.7 | 28.0 | 28.0 | 28.0 |
| Filler | 0 | 0 | 0 | 0 |

Activator Component

| | | | | |
|---|---|---|---|---|
| Difunctional polyepoxide resin | 19.6 | 17.8 | 17.1 | 16.2 |
| Multifunctional polyepoxide resin | 0 | 0 | 1.3 | 1.4 |
| Polyacetoacetate resin | 0 | 0.9 | 0 | 0.9 |
| Epoxy-functional alkoxysilane | 0.3 | 0.5 | 0.6 | 0.6 |
| adhesion promoter | | | | |
| Nitro paraffin | 8.5 | 9.4 | 9.4 | 9.4 |

Coating Composition

| | | | | |
|---|---|---|---|---|
| ¹ Solids Content. | 94.7 | 95.1 | 94.9 | 95 |

¹ Solids weight percent of coating composition (base and activator components).

Water was added to the solid admixtures provided in Table 4 such that the water content of each of the sprayable coating compositions was about 46 wt %, based on the total weight of the sprayable coating compositions.

For adhesion and solvent resistance testing of the water-reducible coating, clad 2024-T3 aluminum substrates were pretreated according to Mil-C-5541 with a chromate conversion coating. For hot Skydrol® resistance testing, clad aluminum substrates were pretreated according to MIL-A-8625 with chromic acid anodization.

The sprayable water reducible coating compositions were sprayed onto the prepared substrates to a dry film thickness of from 0.8 mils to 1.2 mils (20.3 μm to 30.5 μm).

The applied coatings were allowed to partially cure at room temperature (25° C.).

Before the applied water reducible coatings fully cured, such as within 24 hours following application, a two-component polyurethane topcoat was applied to the partially cured water reducible coating. The polyurethane topcoat material was Desothane® HS CA8000/B70846 and was applied to a dry film thickness of from 1.5 mils to 2.5 mils (38 μm to 63 μm).

The multilayer systems consisting of the treated aluminum substrate, the water reducible coating, and the polyurethane topcoat were exposed to a temperature of 25° C. for 7 days to fully cure the multilayer system.

The cured multilayer coatings had a dry thickness from 2.3 mils to 3.7 mils (58 μm to 94 μm).

Test panels were evaluated for adhesion and fluid resistance.

### Example 3

### Solvent Resistance Testing

Solvent resistance of each coating was tested in accordance with American Society for Testing and Materials (ASTM) D5402 (Standard Practice for Assessing the Solvent Resistance of Organic Coatings Using Solvent Rubs). The cured coatings were rubbed back and forth 50 times using firm finger pressure with cheesecloth that was soaked in methyl ethyl ketone (MEK) solvent. Rubbing through the coating to the substrate indicated a failure of the coating due to insufficient cure. Both the coating and the cloth were visually examined for any coating removal.

### Example 4

### Skydrol® Resistance Testing

The overnight ambient cured coated panels were immersed in the hydraulic fluid Skydrol® LD-4 (available from Solutia, Inc.) at a temperature of 160° F. (71° C.) for 1,000 hours. The surfaces of the coatings were checked for paint peeling, blistering, and significant color change. Any signs of coating failure were recorded as “fail”; otherwise, the coatings were recorded as “pass”.

Within 30 min after removing the panels from the hot Skydrol® LD-4, a scratch resistance test was performed according to ISO 1518. (Paints and varnishes—Determination of scratch resistance). ISO 1518 specifies a test method for determining under defined conditions the resistance of a single coating or a multicoat system of paint, varnish or related product to penetration by scratching with a scratch stylus loaded with a specified load. A minimum load of 1,200 gm was recoded as “Pass”. Chromic acid anodized Alclad 2024-T3 was used for the Skydrol® resistance test. A water reducible coating with a dry film thickness of from 0.8 mils 1.2 mils (20.3 μm to 30.5 μm) was applied to the treated aluminum substrate for Skydrol® resistance testing. A polyurethane coating is not applied on top of the coating for the test.

### Example 5

### Crosshatch Adhesion Testing

For crosshatch adhesion testing the test panels consisted of a chromic acid anodized Alclad 2024-T3 substrate with a thickness from 0.8 mils to 1.2 mils (20.3 μm to 30.5 μm) of the primer coating and an overlying layer of a polyurethane topcoat.

Crosshatch adhesion was determined according to ASTM D3359 (Standard Test Methods for Measuring Adhesion by Tape Test), method B, 2009. A crosshatch pattern was scribed through the coating down to the substrate. A strip of 1-inch (25.4 mm) wide masking tape (such as 3M™ 250 tape or equivalent) was applied onto the scribed coating. The tape was pressed down using two passes of a 4.5-pound rubber covered roller. The tape was then removed in one abrupt motion perpendicular to the panel. The adhesion was rated by a visual examination of the coating at the crosshatch area using the provided rating system. Dry adhesion was tested after fully curing the coating system for 7 days. Wet adhesion was tested on a fully cured coating system after immersing the test panel in water at 140° F. (60° C.) for 24 hours. Panels were removed from the water, wiped dry with a paper towel, and tested after 5 minutes. The adhesion of the coating systems was rated as follows:
5B: The edges of the cuts are completely smooth and none of the lattice squares are detached.
4B: Small flakes of the coating are detached at the intersections. Less than 5% of the lattice area is affected.
3B: Small flakes of the coating are detached along edges and at intersections of cuts. The area affected is from 5% to 15% of the lattice.
2B: The coating flaked along the edges and on parts of the squares. The area affected is from 15% to 35% of the lattice.
1B: The coating flaked along the edges of cuts in large ribbons and squares have detached. The area affected is from 35% to 65% of the lattice.
0B: Flaking and detachment worse than for Grade 1B.

The results of the adhesion tests are provided in Table 5.

TABLE 5
Adhesion test results.

| | Comparative | Comparative | Comparative | |
|---|---|---|---|---|
| | Composition | Composition | Composition | Inventive |
| | A | B | C | Composition |
| Hot Skydrol ® resistance (water | <900 gm | <1,200 gm | <1,200 gm | 2,200 gm |
| reducible coating only) | | | | |
| Wet adhesion (water reducible | 5B | 5B | 5B | 5B |
| coating only) | | | | |
| Wet adhesion with topcoat | 2B | 5B | 5B | 5B |
| (polyurethane topcoat was applied | | | | |
| after curing the water reducible | | | | |
| coating for 24 hours.) | | | | |

A comparison of the properties of comparative compositions and an inventive composition are provided in Table 6.

TABLE 6
Properties of comparative and an inventive coating composition.

| | Comparative | Comparative | Comparative | |
|---|---|---|---|---|
| | Composition | Composition | Composition | Inventive |
| Test/Property | A | B | C | Composition |
| VOC (g/L) | 350 | 350 | 350 | 350 |
| Fresh mix viscosity (sec) | 18 | 20 | 20 | 20 |
| 4 Hours pot-life viscosity (sec) | 25 | 40 | 40 | 40 |
| Dry-to-tape time (h) | 2 | 2 | 2 | 2 |
| Solvent Resistance | Pass | Pass | Pass | pass |
| Wet adhesion with water | 5B | 5B | 5B | 5B |
| reducible coating only | | | | |
| ¹ Wet adhesion with the water reducible | 0B | 5B | 5B | 5B |
| coating and the polyurethane topcoat | | | | |
| Wet adhesion with water reducible | Fail | Pass | Pass | Pass |
| coating and topcoat Rating, inter-coat | | | | |
| adhesion failure between the water | | | | |
| reducible coating and the polyurethane | | | | |
| topcoat | | | | |
| ² Scratch Resistance Results after | <900 | <1,200 | <1,200 | 2,200 |
| immersion (70° C./1,000 hours | | | | |
| in Skydrol ® LD-4) | | | | |
| ² Hot Skydrol ® scratch resistance | Fail | Fail | Fail | Pass |

¹ Polyurethane topcoat was applied after curing the water reducible coating for 24 hrs.
² A water reducible coating with dry film thickness of 0.8 mils to 1.2 mils (20.3 μm to 30.5 μm) was applied to the chromic acid anodized clad aluminum substrate for Skydrol ® resistance testing.

Finally, it should be noted that there are alternative ways of implementing the embodiments disclosed herein. Accordingly, the present embodiments are to be considered as illustrative and not restrictive. Furthermore, the claims are not to be limited to the details given herein and are entitled to their full scope and equivalents thereof.

1-82. (canceled)

83. A coating composition comprising:
a polyepoxide-polyamine adduct;
an aromatic/cycloaliphatic polyamine;
a difunctional polyepoxide;
an aliphatic multifunctional polyepoxide; and
a polyacetoacetate.

84. The coating composition of claim 83, wherein the polyepoxide-polyamine adduct comprises the reaction product of reactants comprising a poly-amino-imidazoline and a diglycidyl ether of bisphenol A.

85. The coating composition of claim 83, wherein the aromatic/cycloaliphatic polyamine comprises a methylene bridged poly(cyclohexyl-aromatic) amine.

86. The coating composition of claim 83, wherein the difunctional polyepoxide comprises a difunctional bisphenol A polyepoxide, a difunctional bisphenol F polyepoxide, a difunctional novolac polyepoxide, or a combination of any of the foregoing.

87. The coating composition of claim 83, wherein the aliphatic multi-functional polyepoxide has a number average epoxy functionality from 3 to 6.

88. The coating composition of claim 83, the polyacetoacetate has a viscosity from 100 cPs to 2,000 cPs at 25° C., wherein the viscosity is determined using a Brookfield viscometer.

89. The coating composition of claim 83, comprising:
from 10 wt % to 40 wt % of the polyepoxide-polyamine adduct;
from 0.1 wt % to 2.0 wt % of the aromatic/cycloaliphatic polyamine;
from 10 wt % to 40 wt % of the difunctional polyepoxide;
from 0.5 wt % to 5.0 wt % of the aliphatic multi-functional polyepoxide; and
from 0.3 wt % to 3.0 wt % of the polyacetoacetate,
wherein wt % is based on the total solids weight of the composition.

90. The coating composition of claim 83, wherein the coating composition comprises water.

91. The coating composition of claim 83, wherein the coating composition comprises an organic solvent.

92. The coating composition of claim 91, wherein the organic solvent comprises a nitro paraffin.

93. The coating composition of claim 83, wherein the coating composition comprises a sprayable coating composition.

94. The coating composition of claim 93, wherein the sprayable coating composition has an organic solvent content of from 8 wt % to 18 wt % and a water content of from 37 wt % to 57 wt %, where wt % is based on the total weight of the sprayable coating.

95. The coating composition of claim 83, wherein the coating composition has a volatile organic content (VOC) less than 350 g/L, wherein the VOC is determined according to ASTM D2369.

96. A multilayer coating comprising:
a cured coating prepared from the coating composition of claim 83; and
a cured polyurethane coating overlying the cured coating.

97. A multi-component coating system, wherein the multi-component system comprises:
a polyamine component, wherein the polyamine component comprises:
a polyepoxy-polyamine adduct; and
an aromatic/cycloaliphatic polyamine; and
a polyepoxide component, wherein the polyepoxide component comprises:
a difunctional polyepoxide;
an aliphatic multi-functional polyepoxide; and
a polyacetoacetate.

98. A method of making a coating, comprising:
applying the coating composition of claim 83 to a surface; and
curing the applied coating composition to provide a coating.

99. A coating prepared from the coating composition of claim 83.

100. A coating prepared by the method of claim 98.

101. A part comprising the coating of claim 99.

102. A vehicle comprising the coating of claim 99.
